(19) United States
(12) Patent Application Publication
(10) Pub. No.: US 2016/0182619 A1
(43) Pub. Date: Jun. 23, 2016

(54) DIAMETER ROUTING AGENT TESTING

(71) Applicant: Alcatel-Lucent Canada, Inc., Ottawa (CA)

(72) Inventor: Robert A. Mann, Carp (CA)

(73) Assignee: Alcatel-Lucent Canada, Inc.

(21) Appl. No.: 14/573,525

(22) Filed: Dec. 17, 2014

(51) Int. Cl. H04L 29/08; H04L 29/06

(52) U.S. Cl. CPC H04L 67/104; H04L 67/141; H04L 63/0263; H04L 63/0281

(57) ABSTRACT

Various exemplary embodiments relate to a method performed by a Diameter Routing Agent (DRA) for processing a Diameter message, the method including providing a normal rule set for processing the Diameter message according to a Diameter protocol; providing a disruption rule set for processing the Diameter message in contradiction to the Diameter protocol, wherein the rule set includes a criteria; receiving the Diameter message; determining that the Diameter message meets the criteria; and processing the Diameter message according to the disruption rule set.

### TECHNICAL FIELD

Various exemplary embodiments disclosed herein relate generally to evaluation of communications networks.

### BACKGROUND

Since its proposal in Internet Engineering Task Force (IETF) Request for Comments (RFC) 3588, the Diameter protocol has been increasingly adopted by numerous networked applications. For example, the Third Generation Partnership Project (3GPP) has adopted Diameter for various policy and charging control (PCC), mobility management, and IP multimedia subsystem (IMS) applications. As IP-based networks replace circuit-switched networks, Diameter is even replacing SS7 as the key communications signaling protocol. As networks evolve, Diameter is becoming a widely used protocol among wireless and wireline communications networks.

One significant aspect of the Diameter protocol is Diameter packet routing. Entities referred to as Diameter routing agents (DRAs) facilitate movement of packets in a network. In various deployments, DRAs may perform elementary functions such as simple routing, proxying, and redirect.

### SUMMARY

In light of the present need for network testing, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a Diameter Routing Agent (DRA) for processing a Diameter message, the method including providing a normal rule set for processing the Diameter message according to a Diameter protocol; providing a disruption rule set for processing the Diameter message in contradiction to the Diameter protocol, wherein the rule set includes a criteria; receiving the Diameter message; determining that the Diameter message meets the criteria; and processing the Diameter message according to the disruption rule set. Some embodiments further include enabling the disruption rule set. In some embodiments processing the Diameter message according to the disruption rule set includes discarding the message. In other embodiments processing the Diameter message according to the disruption rule set includes receiving a response to the message; and discarding the response to the message.

In alternative embodiments processing the Diameter message according to the disruption rule set includes transmitting the message to a server; receiving a response to the message; determining a peer associated with the response; waiting a delay; and transmitting the response to the peer. In some embodiments processing the Diameter message according to the disruption rule set includes altering the message. In other embodiments altering the message includes toggling a bit in a header of the message. In alternative embodiments altering the message includes changing a type of the message. In some embodiments altering the message includes changing a proxy flag of the message. In other embodiments altering the message includes changing a retransmission flag of the message. In some embodiments altering the message includes changing an error flag of the message.

Various exemplary embodiments relate to a method performed by a Diameter Routing Agent (DRA) for processing a Diameter rule set, the method including providing a normal rule set for processing the Diameter message according to a Diameter protocol; providing a disruption rule set for processing the Diameter message in contradiction to the Diameter protocol, wherein the rule set includes a criteria and a time; determining that the time is in effect; receiving a connection request from a peer; determining that the peer meets the criteria; and processing the connection request according to the disruption rule set. In alternative embodiments processing the connection request according to the disruption rule set includes waiting a delay; determining that the time is not in effect; and establishing a connection with the peer. In various embodiments processing the connection request according to the disruption rule set further includes enabling the peer in a peer table. In some embodiments processing the connection request according to the disruption rule set includes adding a firewall rule to a set of firewall rules; and ignoring the connection request.

In alternative embodiments processing the connection request according to the disruption rule set further includes waiting a delay; determining that the time is not in effect; and removing the firewall rule from the set of firewall rules. Some embodiments further include receiving a second connection request from the peer; and establishing a connection with the peer. In some embodiments the firewall rule includes an address of the peer. Alternative embodiments further include receiving a capabilities exchange message from the peer, wherein the capabilities exchange message includes the address of the peer.

It should be apparent that, in this manner, various exemplary embodiments enable integrated network testing in Diameter environments. In particular, by including within deployed core network routers configurable capabilities to disrupt network communications.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates an exemplary Diameter Routing Agent;

FIG. 3 illustrates methods of disrupting peer connectivity for negative testing;

FIG. 4 illustrates methods of disrupting message delivery for negative testing;

FIG. 5 illustrates an embodiment of a random disruptive rule;

FIG. 6 illustrates an embodiment of a targeted disruptive rule; and

FIG. 7 illustrates an exemplary hardware diagram for an exemplary Diameter Routing Agent.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or” refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to Diameter networks, it will be understood that the techniques and arrangements described herein may be implemented to facilitate environment testing of network communications in other types of systems that implement multiple types of data processing or data structure.

Before actually deploying in a live network, equipment manufacturers and network operators test the software and/or equipment that is to be deployed, often in a lab setup that mimics the live network. Testing may include error case or negative testing used to gauge how the product(s) and other devices in the network will behave when one or more systems behave improperly or other unexpected things happen. For example, in a Diameter network, unexpected happenings may include messages being lost or delayed, the inability for devices to connect to each other, connections between devices being disconnected, data corruption or incorrect formats, etc. Various tools used to cause disruption in the network are typically not designed specifically for Diameter messaging and so cannot cause fine-grained or very specific disruptions, and thus negative testing conducted using these tools does not reflect genuine network conditions and problems that are likely to occur in the network.

Diameter Routing Agents (DRAs) available today provide only functionalities which conform to the Diameter protocol, and other functions meant to facilitate network traffic through Diameter messaging. The generation of network disruptions meant to evaluate the behavior of DRAs and other networked devices in communication with DRAs is typically defined in hard coding or scripting, and often implemented on third-party devices connected to the network, not integrated within it. As such, users may typically not be empowered to easily and flexibly define more complex behaviors for testing a DRA and other network devices. In view of the foregoing, it would be desirable to provide a method and system that facilitates user definition and extension of DRA message processing behavior to generate network disruptions for testing and debugging purposes. For example, it would be desirable to provide an intuitive interface that enables a user to define testing rules that mimic real-world network disruptions.

Referring now to the drawings, in which like numerals refer to like components or steps, there are disclosed broad aspects of various exemplary embodiments.

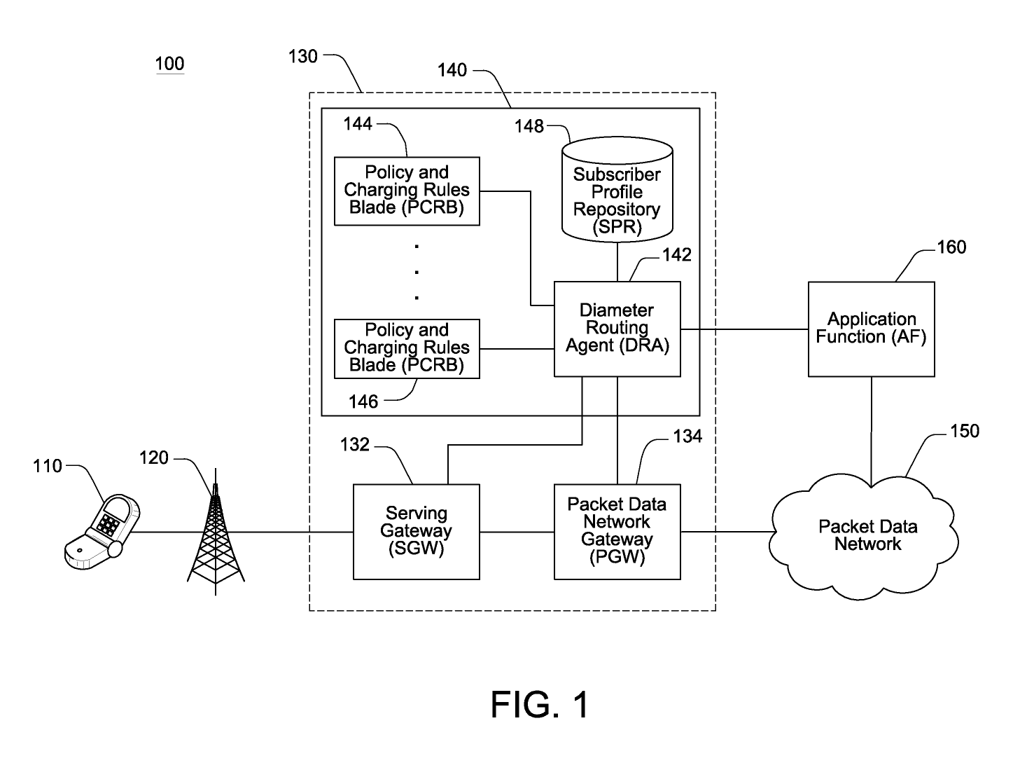

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

As will be described in greater detail below, DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 148 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

As may be seen above, in part because DRAs are capable of handling so many different kinds of requests, in some instances all or most Diameter traffic in a network such as network 100 may be routed through one or more DRAs such as DRA 142. Since DRA 142 is in a central place in the network 100, it is in a prime position to inject controlled chaos into the network when testing is being performed, e.g. by affecting the interaction between any set of devices. Because DRA 142 is a device deployed within network 100, it may be used for negative testing without additional tools. For example, the DRA rule engine may be configured to cause disruptions in a controlled manner, such that it is known what is going wrong in the network and therefore should be known what the effects of the disruptions should be, based on Diameter or vendor protocol requirements. Further, because a DRA is configured to handle Diameter messages, it may be used to analyze Diameter message contents to determine whether disruptions affect only specific users, user sessions, and/or devices as may be expected from such controlled disruptions as they are communicated over the network.

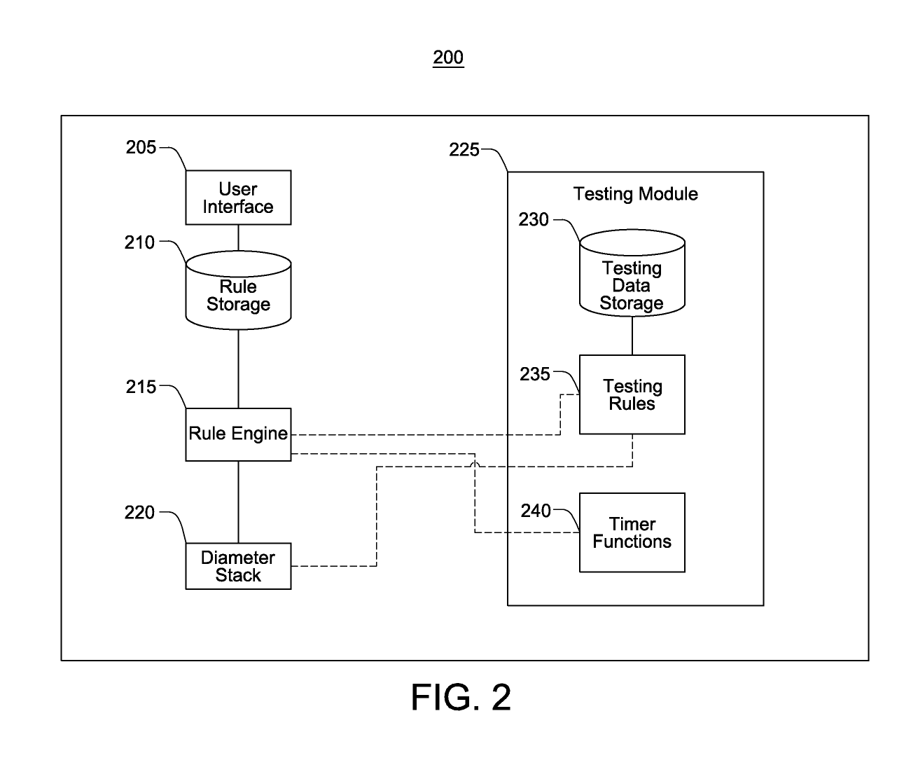

FIG. 2 illustrates an exemplary Diameter Routing Agent (DRA) 200. DRA 200 may include a number of components such as user interface 205, rule storage 210, rule engine 215, Diameter stack 220, testing data storage 230, testing rules 235, and timer functions 240.

DRA 200 may be a standalone device or a component of another system. For example, DRA 200 may correspond to DRA 142 of exemplary environment 100. In such an embodiment, DRA 142 may support various Diameter applications defined by the 3GPP such as Gx, Gxx, Rx, or Sp. DRA may also be configured to behave in violation of the 3GPP for testing purposes. It will be understood that DRA 200 may be deployed in various alternative embodiments wherein additional or alternative applications are supported. As such, it will be apparent that the methods and systems described herein may be generally applicable to supporting any Diameter applications.

Rule engine 215 may include hardware or executable instructions on a machine readable storage medium configured to process a received message by evaluating one or more rules stored in rule storage 210. As such, rule engine 215 may be a type of processing engine. Rule engine 215 may retrieve one or more testing rules, evaluate criteria of the testing rules to determine whether the testing rules are applicable, and specify one or more result of any applicable rules.

Rule storage 210, may be any machine-readable medium capable of storing one or more rules for evaluation by rule engine 215. Accordingly, Rule storage 210, may include a machine-readable storage medium such as read-only memory (ROM), random-access memory (RAM), magnetic disk storage media, optical storage media, flash-memory devices, and/or similar storage media. In various embodiments, rule storage 210 may store one or more rule sets as a binary decision tree data structure. Various other data structures for storing a rule set will be apparent.

Diameter Stack 220 may include hardware or executable instructions on a machine-readable storage medium configured to exchange messages with other devices according to the Diameter protocol. Diameter stack 220 may include an interface including hardware or executable instructions encoded on a machine readable storage medium configured to communicate with other devices. For example, diameter stack 220 may include an Ethernet or TCP/IP interface. In various embodiments, diameter stack 220 may include multiple physical ports.

Diameter stack 220 may also be configured to read and construct messages according to the Diameter protocol. For example, Diameter stack may be configured to read and construct CCR, CCA, AAR, AAA, RAR, and RAA messages. Diameter stack 220 may provide an application programmer's interface (API) such that other components of DRA 200 may invoke functionality of Diameter stack. For example, rule engine 215 may be able to utilize the API to read an attribute-value pair (AVP) from a received CCR or to modify an AVP of a new CCA. Various additional functionalities will be apparent from on the following description.

Rule storage 210 may be any machine-readable medium capable of storing one or more rules for evaluation by rule engine 215. Accordingly, rule storage 210 may include a machine-readable storage medium such as read-only memory (ROM), random-access memory (RAM), magnetic disk storage media, optical storage media, flash-memory devices, and/or similar storage media. In various embodiments, rule storage 210 may store one or more rule sets as a binary decision tree data structure. Various other data structures for storing a rule set will be apparent.

It will be understood that, while various components are described as being configured to perform functions such as evaluating testing rules, such configurations may not require any testing rules to be present in rule storage. For example, rule engine 215 may be configured to evaluate a testing rule even if no such rule is stored in rule storage 210. Thereafter, if a user adds such a rule to rule storage, rule engine 215 may process the rule as described herein. In other words, as used herein, the phrase “configured to” when used with respect to functionality related to rules will be understood to mean that the component is capable of performing the functionality as appropriate, regardless of whether a rule that requests such functionality is actually present.

User interface 205 may include hardware or executable instructions on a machine-readable storage medium configured to enable communication with a user. As such, User interface 205 may include a network interface (such as a network interface included in Diameter stack 220), a monitor, a keyboard, a mouse, or a touch-sensitive display. User interface 205 may also provide a graphical user interface (GUI) for facilitating user interaction. User interface 205 may enable a user to customize the behavior of the DRA 200. For example, User interface 205 may enable a user to define rules for storage in rule storage 210 and evaluation by rule engine 215. Various additional methods for a user to customize the behavior of DRA 200 via User interface 205 will be apparent to those of skill in the art.

In some embodiments the testing rules 235 may be a part of the rule storage 210. Likewise the testing data storage 230 may represent information stored for other purposes such as, for example, logging or debugging, by the DRA 200. In some embodiments the Timer functions 240 may be part of rule engine 215 or another module in DRA 200 responsible for triggering timed events.

The contents of Diameter messages may vary depending on the application and command type. For example, an Rx RAA message may include different data from a Gx CCR message. Such differences may be defined by various standards governing the relevant Diameter applications. Further, some vendors may include proprietary or otherwise non-standard definitions of various messages. As explained below, some message types may be corrupted or changed to another type, or otherwise configured in contravention of the various standards, in order to cause a disruption for negative testing purposes.

Testing module 225 may include hardware or executable instructions on a machine readable storage medium configured to manage timer functions 240, testing rules 235, and testing data storage 230. Rule Engine 215 may use testing rules 235 to store specific testing rules. Testing rules 235 may include rule 500 and 600, and may be used to perform methods 300 and 400. Rules engine 215 may determine testing rules applicable to each Diameter message. Rules engine 215 may be used in conjunction with testing rules 235 and timer functions 240 to create specific disruptions that are random, periodic, or scheduled, and broad or narrow in scope depending on factors as described below. For example, a disruption may be focused such as to affect a single Diameter message or a single user session, or broad such as disrupting all messages to a particular device.

The rules engine 215 may be used to cause a number of scenarios to negatively affect the successful operation of a Diameter network, and data may be collected to determine the effect on other network devices when such problems happen such as on base station 120, SGW 132, PGW 134, components within EPC 140 such as PCRBs 144, 146 and DRA 142, and AF 160. Problems may include problems with peer connectivity; problems with message delivery including higher than expected latency, messages that go undelivered, and messages that have invalid and/or unexpected content; problems with message identity; and other problems where a protocol is not followed.

While rule storage 210, rule engine 215, Diameter stack 220, testing data storage 230, testing rules 235, and timer functions 240 are illustrated as separate devices, one or more of these components may be resident on multiple storage devices. Further, one or more of these components may share a storage device. For example, rule storage 210, rule engine 215, testing data storage 230, testing rules 235, and timer functions 240 may all refer to portions of the same hard disk or flash memory device.

While rule storage 210, rule engine 215, Diameter stack 220, testing data storage 230, testing rules 235, and timer functions 240 are illustrated as individual components, multiple instances of one or more of these components may be functioning at a time. This may facilitate enabling and disabling negative testing so that negative test rules are not accidentally used for production situations. For example multiple instances of rule engine 215 may run at a time; for instance, one may run for normal behavior, and another for negative testing. Likewise, rule storage 210 and testing data storage 230 may be separate, and testing data storage 230 only activated during negative testing so that rules for disruptions that may be stored in testing data storage 230 and rules for normal functioning stored in rule storage 210 are isolated from one another. Additionally, multiple instances or versions of test and normal rules may be kept so that different conditions, both with and without disruptions, may be enabled and disabled without accidentally overlapping test conditions.

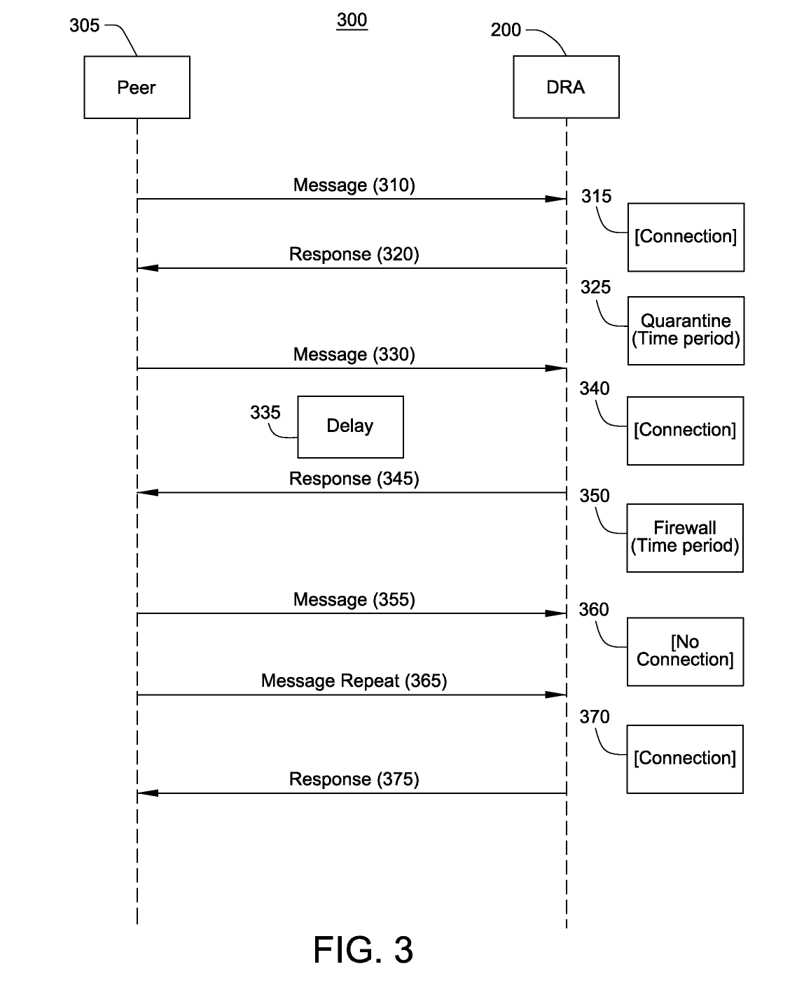

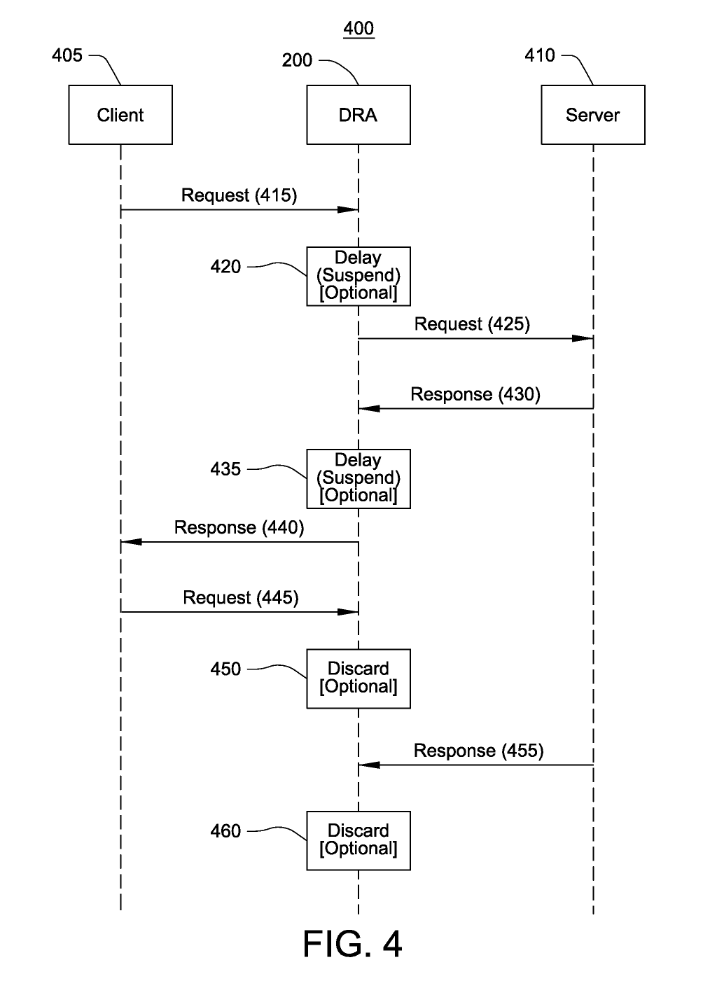

FIGS. 3-4 illustrate exemplary message diagrams 300, 400, illustrating methods of processing Diameter messages. An arrow in FIGS. 3-4 may illustrate a message sent from one network node to another network node. Accordingly, an arrow may represent both a step of sending the message and a step of receiving the message. A Diameter message may include a plurality of fields or attribute value pairs (AVPs). Various fields of the Diameter message may be required by a Diameter application while other messages are optional.

Peer connectivity disruptions may be generated in the DRA 200. Under normal conditions, the DRA 200 may be configured to specify its peer devices. The information for each of the peer devices may be stored in a peer table. A connection to a peer device may be made based upon the Diameter ID of the peer device. The Diameter stack 220 may use the peer table to keep track of its peers. If a Diameter message is received with a Diameter ID that is not found in the peer table, then a routing table may be used to determine a route that may be used to transmit the Diameter message. The route identifies the peer device to which the Diameter message is to be sent. The DRA 200 may provide actions in the peer table context in the rules engine 215 that may be used to negatively affect peer connections.

For example, a disconnect action using disconnect functionality already present in diameter stack 220 may cause a peer 305 with a given identity to be disconnected, in effect disengaging the connection with the peer and causing an interruption in traffic to and from that peer. Such a negative test would allow observation through examination of log files or information stored in testing data storage 230 of whether Diameter and other protocols and standards were followed after the disconnection—for example, the connection may be reestablished and the messages that were in transit at the time the disconnection occurred may be re-transmitted, or the message loss may be compensated for in other ways (e.g. if a session terminate message is lost, in the PCRF there will be data left behind in the database that may be cleaned up at some point).

FIG. 3 illustrates an exemplary message diagram 300 illustrating methods of disrupting peer connectivity for negative testing. Steps 310, 315 and 320 demonstrate communications between a DRA 200 and a peer device 305 according to the Diameter protocol, including a message 310, an accepted connection 315, and a response 320. Examples of disruptions to peer connectivity with more granularity than a brief disconnection may include a quarantine 325 or a firewall 350 imposed with some limited duration. A quarantine 325, for example, may cause the peer 305 with a given identity to be disconnected, and prevent the peer 305 from reconnecting for a specified period of time expressed by a delay 335, by not attempting to connect to it and/or rejecting a message 330 such as a capabilities exchange requests from the peer by not sending a response 345 until a later time determined by the delay 335. A firewall 350 may cause the peer with a given identity 305 to be disconnected, and prevent the peer 305 from reconnecting by not accepting the connection 360 for a specified period of time by using the operating system firewall to block incoming traffic in the form of messages 355 from the IP addresses that the peer 305 had previously advertised in a capabilities exchange message. Incoming messages would have to be repeated at a later time 365 before a connection is established 370 and a response sent 375 from the DRA 200 to the peer 305. Note that a quarantine 325 and a firewall 350 are distinct in part because in a quarantine a network connection may be maintained or quickly reestablished between the DRA 200 and the peer 305, such that the peer socket connection would be accepted 340 if the peer connects to the DRA by sending a message 330, but the incoming communication 330 would be rejected at the Diameter protocol level. For example, during a quarantine, at the Diameter protocol level the DRA 200 may do nothing with incoming requests from the peer such as message 330 until the quarantine period determined by the delay 335 expires, as may be indicated by a timer function 240, and then DRA 200 may attempt to reestablish the connection by sending a response 345. Thus, so long as a timer function 240 was in effect, the quarantine will continue. In a firewall 350, the DRA 200 would effectively disappear from the network from the perspective of the peer device 305, because the DRA 200 would not respond to the peer device 305, when sending a message 355 it would not even be able to establish a network connection with the DRA 200. So long as a timer function 240 was in effect, the DRA 200 would ignore connection requests from the peer 305.

A quarantine may be implemented, for example, by maintaining a quarantine list with an expiry time, timer task, or other time-keeping mechanism regulated by timer functions 240, and creating a rule executed by the rule engine 215 such that when an inbound connection such as message 330 is attempted, the DRA 200 will check to see if the peer 305 is included in the quarantine list, and will reject the connection; and for outbound messages, an enable/disable bit in the peer table will be set to disable, and a task may be scheduled for a specified time or delay using a timer function 240 to wake up and enable the connection by setting the enable/disable bit for the peer in the peer table to enable. A firewall may be implemented by adding a rule to the rule engine 215 to manipulate the firewall rules in the DRA 200, where the firewall rule would be removed at the end of some specified duration as specified by a timer function 240.

FIG. 4 illustrates an exemplary message diagram 400 illustrating methods of disrupting message delivery for negative testing. Diameter messages are defined in the protocol as a request/response pair that originates at a client 405 as a request 415, 425, travels to a server 410, often through a DRA 200, then travels back to the client 405 through DRA 200 as a response 430, 440. For example, an AF 160 may send a message through DRA 142 to a PCRB 144, which may send a response back to the AF 160 through DRA 142. Message delivery disruptions may be generated in the DRA 200 that mimic typical disruptions seen in networks. In real network conditions, message delivery problems may fall into three categories—messages that suffer from higher than expected latency, messages that go undelivered, and messages that have invalid and/or unexpected content. For example, high latency may occur when messages take longer than expected to be routed and/or processed to or through a DRA 200, which may have an adverse effect on a client device 405—such as base station 120, SGW 132, PGW 134, components within EPC 140 such as PCRBs 144, 146, or AF 160—that is waiting for a response to the client's requests such as a request 415.

High latency disruption may be introduced, for example, by adding the capability to the Diameter stack 220 to suspend the processing of specific received messages for a period of time. The rule engine 215 might be configured with a rule to detect a message, wait for a specified period, and then perform processing on the message. For example, a message such as a request 415 received from a client 405 such as the PCRF function of a PCRB 144, 146 may be suspended at the DRA 200 before 420 or after 435 being forwarded to the server 410, for example, as a request 425, so that a response 430 forwarded 440 to the client 440 through DRA 200 after it is received by DRA 200 from the server 410 may be delayed 420 before being sent by DRA 200 to the server 410, or delayed 435 before returning from the server 410 through DRA 200 to the client 405. Delaying processing 420, 435 of the message at the DRA 200 would have the appearance of the message taking longer to route through the network, mimicking high latency. Note that the granularity of any delay may be configurable by a user, and may be variable, e.g. a random amount of time within a range. In some embodiments, a task scheduler may be run in communication with the rule engine to signal the end of a specified delay. A specified level of granularity may be managed by the scheduler, such that a smaller level of granularity, e.g. a second, may result in the timer checking on tasks every second to determine when they should resume; to the converse, with granularity on the order of minutes, the timer granularity may be set to a longer period of time, for example, a minute or more, to satisfy the rule conditions for the disruptions. In some embodiments, user interface 205 may be used to enable or disable the task scheduler, and may be used to set the granularity of the task scheduler. In some embodiments, disabling the task scheduler may disable the DRA's capability to delay messages 420, 435; disabling the task schedule may free memory and other resources of DRA 200 to handle messages and other tasks in a production situation.

As described above, Diameter messages are defined in the protocol as a request/response pair that originates at a client 405 as a request 415, 425, travels to a server 410, often through a DRA 200, then travels back to the client 405 as a response 430, 440. For example, an AF 160 may send a message through DRA 142 to a PCRB 144, which may send a response to the AF 160 through DRA 142. When a Diameter request/response pair does not complete the full cycle such that the client sends request 415 to the DRA 200, which forwards it 425 to a server 410 and the client 405 subsequently receives a response 440 through the DRA 200 from server 410, the client and server can get out of sync, requiring some remedial action such as auditing to be taken to correct the problem. Additionally, the DRA 200 may maintain state information regarding a session; so the possibilities for being out of sync may be: the client 405 may be out of sync with the DRA 200 and the server 410, but the DRA 200 and server 410 are in sync (e.g. a request 415 was sent by the client 405 but never received or incorrectly processed at the DRA 200); the client 405 and the DRA 200 are in sync, but out of sync with the server 410 (e.g. a request 415 was sent by the client 405 and received by the DRA 200, but a message 425 or 430 was lost between the DRA 200 and the server 410); or the client 405 is out of sync with DRA 200 which is further out of sync with server 410 (e.g. if there are multiple pieces of state information that the DRA 200 should maintain to be compliant with the protocol, but only some of the pieces are maintained). As a further example, rule engine 215 and Diameter stack 220 may execute rules to make routing decisions dynamically for routing request messages 415, 425 between the client 405 and server 410, and store the routing decision in a mapping table so that responses 430 originating from servers such as server 410 may each be sent back 440 by the DRA 200 to the correct client such as client 405. As an example, in live network conditions, messages may be lost, for example, a request such as requests 415, 425 may be lost between the client 405 and DRA 200 or between the DRA 200 and server 410; a response such as responses 430, 440 may be lost between the server 410 and the DRA 200 or between the DRA 200 and the client 405; and the request 415 and response 430 may be processed and/or stored incorrectly at the DRA 200.

In order to test such real conditions, a rule may be added to rule storage 210 using user interface 205 such that a Diameter Discard 450, 460 is performed on a message such that a request 445 never reaches the intended server 410 because the request 445 is discarded 450 by the DRA 200; or that the server's response 455 never reaches the client 405 that sent the request 445 because the response 455 is discarded 460 by the DRA 200. The user interface 205 may allow full flexibility in how rule tables are ordered, such that a Diameter request 445 or response 455 may be discarded before, during or after other rule processing at the rule engine 215, thus allowing the client 405, DRA 200 and server 410 to get into various combinations of inconsistent state. For example, a request 445 may arrive at DRA 200 from a client 405 and be discarded immediately 450, before any processing, mimicking a message loss between the client 405 and the DRA 200; the message 445 from the client 405 may be received at DRA 200 and processed but then discarded 450 before it is sent to the server 410, mimicking a message loss between the DRA 200 and the server 410; the response 455 from the server 410 to the DRA 200 may be discarded 460 at arrival before any processing, mimicking a message loss between the server 410 and the DRA 200; the message 455 from the server 410 may be received at DRA 200 and processed but then discarded 460 before it is sent to the client 405, mimicking a message loss between the DRA 200 and the client 405; or messages 445, 455 may be successfully exchanged between the client 405 and server 410 through the DRA 200, but the DRA 200 may store mapping or other information improperly, such that it appears the DRA 200 is out of sync with both the client 405 and the server 410. Note that such rules are for negative testing purposes and thus violate Diameter protocol which specifies that every request 445 from a client 405 should be forwarded to a server 410 and should have a response that is transmitted to the client 405. Nevertheless, a Discard command may be implemented in the Diameter stack 220 for other reasons, for example, to protect the Diameter stack 220 in an overload situation.

The standards for Diameter applications define the content of specific messages in terms of message values consisting of Attribute Value Pairs (AVPs) that may, must and must not be present. In addition, AVPs themselves may be defined in terms of values that are expected, for example, in their headers. In normal (non-testing) operation consistent with the Diameter protocol, specific bits of messages or of specific AVPs may be validated against a Diameter dictionary, and messages with invalid content may be rejected, modified to conform to the protocol, or in some cases errors may be ignored if that is preferred by a network operator or vendor. A user interface 205 may be used to adjust actions so that during testing, actions may be taken to modify the content of specific or random Diameter messages and the AVPs in them so the content of a message is invalid. What action may be taken may be configured to differ depending on the type of message, for example, request or response messages, or for general message manipulation.

For example, the rule engine 215 may indicate that for specified or random request messages the set-proxy flag should be cleared, indicating that the message is not proxyable, in violation of the Diameter protocol. As another example, if messages are received with the set-retransmission flag set, the rule engine 215 may indicate that for specified or random request messages the flag should be cleared, such that it appears that a request message was transmitted twice, and if a second response arrives, it will appear that the response is in error because the DRA 200 may attempt to take the same set of processing actions twice, which may cause problems at the DRA 200 or elsewhere in system 100. In an example applicable to a response message, rule engine 215 may indicate that for specified or random request messages the setErrorFlag may be set or cleared to make the message appear to contain an error result, or to have been indicating a successful result when an error was in fact indicated.

In general, in either request or response messages the rule engine 215 may introduce disruptions by setting or clearing the Mandatory (M), Protected (P), or Vendor Specific (V) bits in an AVP header, where the V bit may indicate whether the optional Vendor-ID field is present in the header, the M bit may indicate whether support of the AVP is required (and thus whether the message must be rejected by a client 405 or a server 410 if the value of the AVP is unrecognized or incorrect), and the P bit may indicate whether the message is encrypted. As another example, the rule engine 215 may corrupt the content of the AVPs for a particular or random set of messages. For example, the Rule engine 215 may add or remove AVPs, move AVPs to different locations within a message, have values added or removed from AVPs, or change message application or command types—for example, transmuting a Gx CCR to an Rx ARR—all of which may render the content of the message unexpected or invalid to a recipient. These disruptions may be used in combination; for example, the rule engine may corrupt the value of an AVP and set or clear the M bit such that the value of the message is both required and incorrect; in another example the M bit may be set and the V bit cleared so that the message appears to be required, but the type of message not identifiable by the client 405 or server 410. Other disruptions may be caused by tampering with expected message contents. For example, message identifiers and identifiers added to the message while in transit in the network may be tampered with, so that messages that arrive would be unexpected (because the identifiers found in a response would not match the identifiers found in the request).

The disruptions described above may be controlled in a variety of ways, including granularity, frequency, and how widespread each disruption is. For example, a disruption may occur once or be repeated at a definable (or random according to a variable) interval, it may last for a defined or random period of time, and may affect one device or many. The granularity of a disruption may be controlled using rule criteria 210 or by using randomly generated values. The frequency of a disruption may be controlled by using scheduled rule tables 215 or by using randomly generated values. For example, disruptive actions can be placed in specific rule tables 210 and those rule tables scheduled to only be active for well specified periods of time. For example, a rule table stored in rule storage 210 that adds random amounts of delay to some messages might only be scheduled to run during a pre-determined “busy hour” when such a disruption may be more likely to happen as the network may be more likely to operate under more load, and the disruption is more likely to have a negative effect.

As noted above, test data may be stored in testing data storage 230 and timers may be kept 240 to track disruptions. Thus, the information from prior disruptions may be used as feedback for decisions of whether to perform disruptions for current messages awaiting processing at the DRA 200. For example, the DRA 200 may use functionality such as generic bindings or calculator contexts to keep track of already-performed disruptions such as when a disruption was last performed, or how many times a disruption has been performed; this information may then be used in conjunction with rule tables 210 and information from incoming messages to decide whether a particular disruption should be performed. DRA 200 may access the contents of Diameter messages as attributes in rule engine 215; a rule in table 210 may conditionally take disruptive action on processing another rule based on its message content.

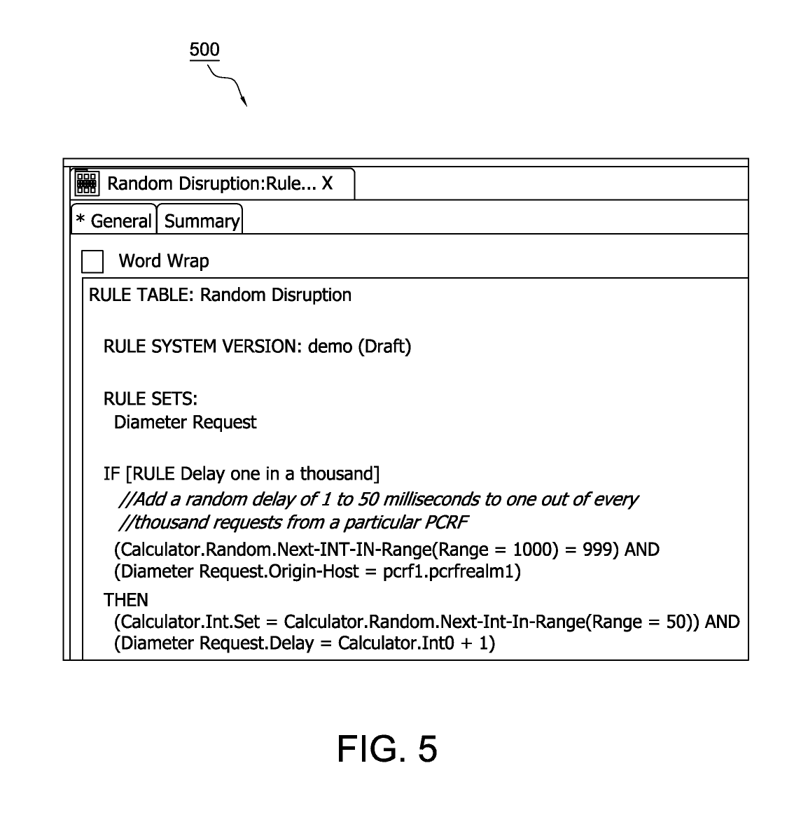

FIG. 5 illustrates an embodiment of a random disruptive rule 500. For example, by generating random numbers within a specified range, and taking action only when a randomly generated value is equal to some particular value, a designated disruption will occur only periodically. Thus, rule 500 may introduce a random latency between 1 and 50 milliseconds to one in a thousand requests sent from a particular device.

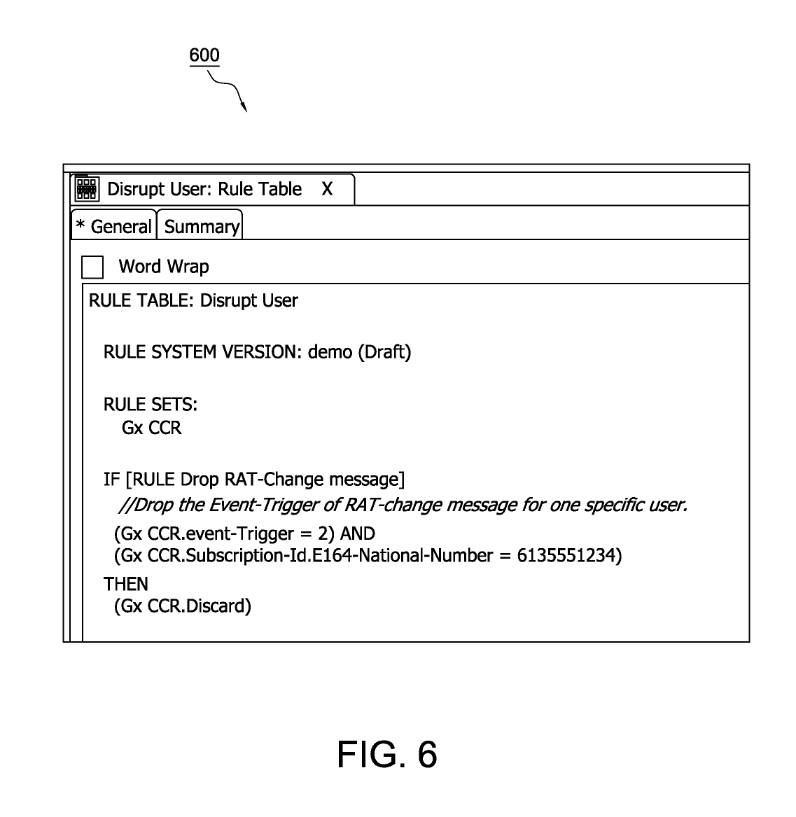

FIG. 6 illustrates an embodiment of a targeted disruptive rule 600. In the example rule 600, there is an event triggering a Discard for any Diameter Gx CCR message received at the DRA 200 for a specific user. As may be understood from this example, it is possible to narrow the disruptive effect to a single specific user, or to a set of users, or to a specific message type related to a specific user. Narrowing the disruption to a very narrow scope may facilitate a determination of whether only the expected user(s)/session(s) are being disrupted by a controlled test or whether other users/sessions are also unexpectedly being disrupted. Thus, tasks may be limited to a specific subset of messages. Where tasks are limited, but a test set is large, for example, based on the historical data of millions of subscribers, a small portion may be deliberately disrupted in order to verify that only those subscribers deliberately disrupted have improper service, but other subscribers are functioning properly.

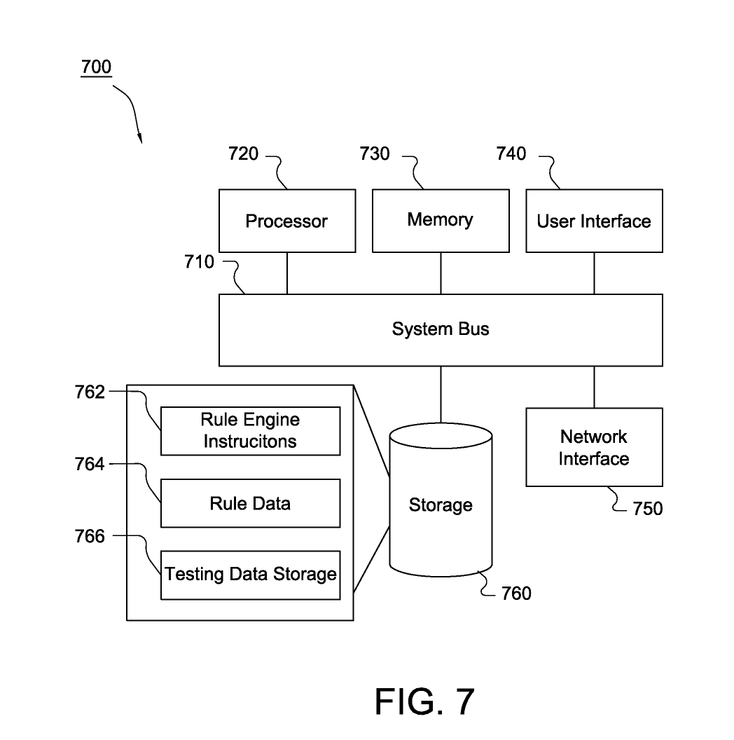

FIG. 7 illustrates an exemplary hardware diagram for a device 700 such as device including a DRA. The exemplary device 700 may correspond to DRA 142 of FIG. 1 and DRA 200 of FIG. 2. As shown, the device 700 includes a processor 720, memory 730, user interface 740, network interface 750, and storage 760 interconnected via one or more system buses 710. It will be understood that FIG. 7 constitutes, in some respects, an abstraction and that the actual organization of the components of the device 700 may be more complex than illustrated.

The processor 720 may be any hardware device capable of executing instructions stored in memory 730 or storage 760. As such, the processor may include a microprocessor, field programmable gate array (FPGA), application-specific integrated circuit (ASIC), or other similar devices.

The memory 730 may include various memories such as, for example L1, L2, or L3 cache or system memory. As such, the memory 730 may include static random access memory (SRAM), dynamic RAM (DRAM), flash memory, read only memory (ROM), or other similar memory devices.

The user interface 740 may include one or more devices for enabling communication with a user such as a network administrator. For example, the user interface 740 may include a display, a mouse, and a keyboard for receiving user commands.

The network interface 750 may include one or more devices for enabling communication with other hardware devices. For example, the network interface 750 may include a network interface card (NIC) configured to communicate according to the Ethernet protocol. Additionally, the network interface 750 may implement a TCP/IP stack for communication according to the TCP/IP protocols. Various alternative or additional hardware or configurations for the network interface 750 will be apparent.

The storage 760 may include one or more machine-readable storage media such as read-only memory (ROM), random-access memory (RAM), magnetic disk storage media, optical storage media, flash-memory devices, or similar storage media. In various embodiments, the storage 760 may store instructions for execution by the processor 720 or data upon with the processor 720 may operate. For example, the storage 760 may store rule engine instructions 762 for performing network processing according to the concepts described herein. The storage may also store Rule Data 764 and Testing Data Storage 766 for use by the processor executing the rule engine instructions 762.

According to the foregoing, various exemplary embodiments provide for network testing. In particular, by performing negative testing on network production devices using rules and other Diameter and DRA functionality.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a Diameter Routing Agent (DRA) for processing a Diameter message, the method comprising:
providing a normal rule set for processing the Diameter message according to a Diameter protocol;
providing a disruption rule set for processing the Diameter message in contradiction to the Diameter protocol, wherein the rule set comprises a criteria;
receiving the Diameter message;
determining that the Diameter message meets the criteria; and
processing the Diameter message according to the disruption rule set.

2. The method of claim 1, further comprising enabling the disruption rule set.

3. The method of claim 1, wherein processing the Diameter message according to the disruption rule set comprises discarding the message.

4. The method of claim 1, wherein processing the Diameter message according to the disruption rule set comprises:
receiving a response to the message; and
discarding the response to the message.

5. The method of claim 1, wherein processing the Diameter message according to the disruption rule set comprises:
transmitting the message to a server;
receiving a response to the message;
determining a peer associated with the response;
waiting a delay; and
transmitting the response to the peer.

6. The method of claim 1, wherein processing the Diameter message according to the disruption rule set comprises altering the message.

7. The method of claim 6, wherein altering the message comprises toggling a bit in a header of the message.

8. The method of claim 6, wherein altering the message comprises changing a type of the message.

9. The method of claim 6, wherein altering the message comprises changing a proxy flag of the message.

10. The method of claim 6, wherein altering the message comprises changing a retransmission flag of the message.

11. The method of claim 6, wherein altering the message comprises changing an error flag of the message.

12. A method performed by a Diameter Routing Agent (DRA) for processing a Diameter rule set, the method comprising:
providing a normal rule set for processing the Diameter message according to a Diameter protocol;
providing a disruption rule set for processing the Diameter message in contradiction to the Diameter protocol, wherein the rule set comprises a criteria and a time;
determining that the time is in effect;
receiving a connection request from a peer;
determining that the peer meets the criteria; and
processing the connection request according to the disruption rule set.

13. The method of claim 12, wherein processing the connection request according to the disruption rule set comprises:
waiting a delay;
determining that the time is not in effect; and
establishing a connection with the peer.

14. The method of claim 13, wherein processing the connection request according to the disruption rule set further comprises:
enabling the peer in a peer table.

15. The method of claim 12, wherein processing the connection request according to the disruption rule set comprises:
adding a firewall rule to a set of firewall rules; and
ignoring the connection request.

16. The method of claim 15, wherein processing the connection request according to the disruption rule set further comprises:
waiting a delay;
determining that the time is not in effect; and
removing the firewall rule from the set of firewall rules.

17. The method of claim 16, further comprising:
receiving a second connection request from the peer; and
establishing a connection with the peer.

18. The method of claim 15, wherein the firewall rule comprises an address of the peer.

19. The method of claim 18, further comprising receiving a capabilities exchange message from the peer, wherein the capabilities exchange message comprises the address of the peer.
